(19) United States
(12) Patent Application Publication
(10) Pub. No.: US 2004/0225546 A1
(43) Pub. Date: Nov. 11, 2004

(54) Method and apparatus for monitoring business process flows within an integrated system

(76) Inventors: Roland Oberdorfer, Mountain View, CA (US); Mark Goetz, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/434,794

(22) Filed: May 9, 2003

(51) Int. Cl. G06F 17/60

(52) U.S. Cl. 705/8

(57) ABSTRACT

The invention is a system that can be used in conjunction with an enterprise application integration system to monitor and track end-to-end business processes. The invention also provides triggers that can alert individual users, user groups or system administrators in the event of errors or other disruptions. The system automatically generates and forwards messages whenever an error occurs.

### BACKGROUND OF THE INVENTION

1. Field of the Invention

The present invention relates to monitoring and tracking business process flows within an Enterprise Application Integration (EAI) solution and for providing system-wide monitoring, tracking, and error reporting for processes used in conjunction with an EAI system.

2. State of the Art

Modern business relies upon efficient flow of information which can be improved by monitoring and tracking business processes. Historically, businesses acquired software applications and/or wrote their own applications, leading to an aggregation of disjoined applications, many of which could not share information. Such an “ad hoc” collection of applications made troubleshooting errors extremely difficult. Briding software applications known as “middleware” partially manage or broker information transfers between applications. Other system-wise solutions, such as an EAI system, allow applications to interface with a network and reduces the amount of adaptation needed for applications to interoperate. Information movement has also been aided by the development of an “application network” which uses a networked EAI system to move information throughout a network.

As mentioned, troubleshooting applications operating in an EAI system is complex, time consuming and expensive due to the complexities of problem identification and fault allocation. Detection of the nature of the problem, such as the specific application or user of an application is not trivial. While the identified problem may be a hardware or software problem, the problem may also be a missing part of the process, such as a missing electronic message, needed for the completion of the process. Furthermore, business processes, such as electronic commerce processes may further complicate an integrated system by generating and using electronic messages as a mechanism for data exchange between applications. Such a system may have applications which depend upon sending or receiving electronic messages, and when a message is not received, the process may halt with no automatic notification.

Previous approaches for detecting problems in an integrated environment have relied upon trial and error techniques or marginally automated approaches. Furthermore, many software programs do not have a mechanism built in to track and/or record detected problems. Thus, an approach is needed to facilitate monitoring and tracking of end-to-end business processes and report errors within an enterprise application integration system.

### BRIEF SUMMARY OF THE INVENTION

The present invention includes an apparatus and method for monitoring and tracking process flows. Multiple computers operating “middleware” are connected through a network forming an integrated system, such as an EAI system. Middleware software also operates on the multiple computers through the EAI system. The apparatus also uses a relational database operating in conjunction with the EAI. The relational database contains a definition of the process to be tracked and also includes information identifying the types of electronic messages required by the process. One exemplary embodiment uses a listening or triggering means that subscribes to system service request messages that cross the interface of the EAI system. The listener or triggering means parses press parameter data from the system service request, inserts the process parameter data into the relational database and then compares the process parameter data with process parameter value limits stored in the database. If process parameter data is missing, out of sequence, late, or otherwise unacceptable, the listener activates an alert. An alert mechanism sends a message giving information about the error to a designated source.

### BRIEF DESCRIPTION OF THE SEVERAL VIEWS OF THE DRAWINGS

These and other features, aspects, and advantages of the present invention will become better understood with regard to the following description, appended claims, and accompanying drawings. In the drawings which depict various aspects of exemplary embodiments of the present invention.

FIG. 1 is a flowchart of a sample electronic order fulfillment process wherein the present invention may be practiced.

FIG. 2 is a block diagram of a monitoring process, in accordance with an exemplary embodiment of the present invention.

FIG. 3 is a block diagram of an alert notification structure, in accordance with an exemplary embodiment of the present invention.

FIG. 4 is a flowchart of a monitoring process, in accordance with an embodiment of the present invention.

FIG. 5 illustrates a transaction process, in accordance with an embodiment of the present invention.

FIG. 6 is a block diagram of an alert system, in accordance with the present invention.

### DETAILED DESCRIPTION OF THE INVENTION

One exemplary embodiment of the present invention is directed to a method and an apparatus for monitoring and tracking end-to-end business processes within an enterprise application integration system. The present invention may be integrated within an application network using rmiddleware and a relational database.

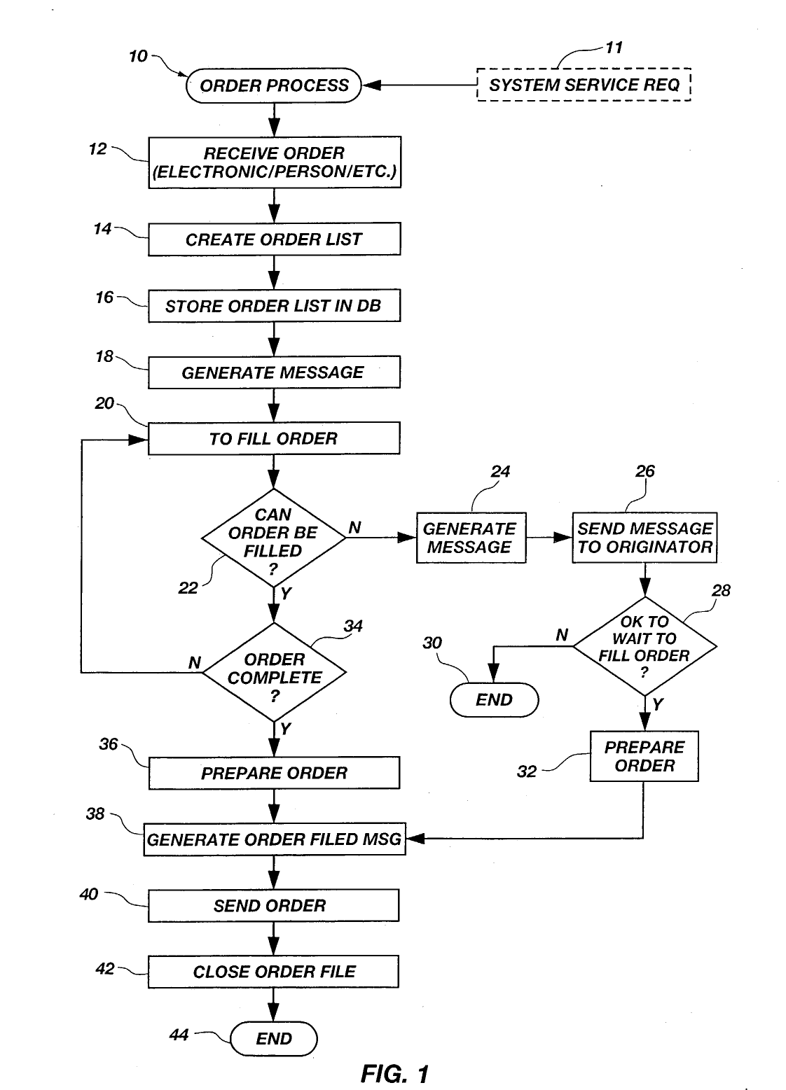

The present invention may be used with a business process that includes multiple steps that may be documented with electronic messages. Each electronic message is part of a sequence of messages that document a process. A process consists of a plurality of electronic messages sent in a specific sequence and within specific intervals. By way of example and not limitation, one exemplary process includes an order fulfillment process which facilitates electronic order placing and processing through a network, such as the Internet. By way of example, a flowchart of a typical electronic order fulfillment process is shown in FIG. 1. A process 10 begins when a system service request 11, an example of which is an order sent by a customer via a network, such as the Internet. Once the system service request 11, for example the order, has been received 12, a system service list, an example of which is an order list, is created 14 and is stored 16 into a database, such as a relational database. An electronic message is generated 18 that constitutes part of the, for example order, process. In the order process example, the system service or order request is sent 20 to the appropriate department to be filled. This department checks to see if the order may be filled 22. If stock is not available, an exception message, such as a backorder message 24 may be sent 26 to the originator of the order. The message informs the originator of the delay and asks the originator if the delay is acceptable 28. If the originator is not willing to wait for the back order and the item constitutes the entire order, the process terminates 30. If the originator is willing to wait 32, the item will be sent once additional stock is received and an order fulfilled message 38 is sent. If the order can be fulfilled 32 order list is checked to see if the order is complete 34. If the order is not complete the remaining parts of the order are directed for fulfillment and the cycle repeats from block 20 of the process. If the order is complete, the order is prepared 36 for shipment. The system then generates 38 a system service request fulfilled message. The order is then sent 40 and the order file is closed 42 with the process terminating 44.

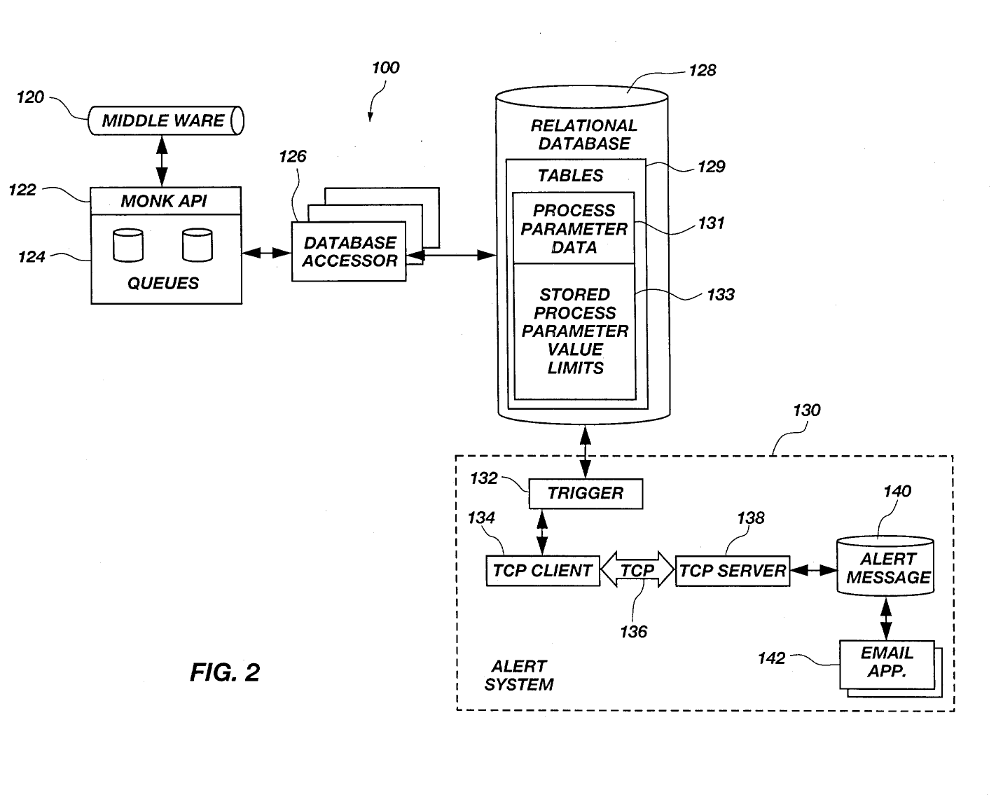

FIG. 2 is a block diagram of a monitoring system 100 for monitoring process flows, in accordance with an exemplary embodiment of the present invention. System 100 includes a messaging overlay application, illustrated as middleware 120, for providing the bridge between the EAI and the individual software applications. Middleware 120 also bridges the EAI and the software used for writing data to a relational database 128. Middleware 120 may adapt disparate software applications to function as part of an integrated system. By way of example, middleware 120 may be any one of a variety of standard middleware packages that are capable of publishing and subscribing, as understood by those of ordinary skill in the art, and may include or be compatible with an electronic mail application. One such middleware package is “e*gate,” produced by See Beyond Technology Corp. of Monrovia, Calif. Middleware 120 processes messages that cross the network. In an exemplary embodiment, middleware 120 interfaces with an application program interface (API) such as the Monk API 122, also available from See Beyond Technology Corp.

The Monk API interfaces with the middleware 120 and facilitates both access and control of a software application. In the present invention, Monk API 122 provides an interface between the middleware 120 and the interface with the relational database 128. While Monk is the programming language used in the exemplary embodiment, any suitable programming language, including Java may also be used for an interfacing API.

Returning to FIG. 2, the Monk API 122 parses each message that crosses the middleware 120 for process parameter data and places this extracted process parameter data into a queue 124. The queues 124 may contain extracted information such as process parameter data from a plurality of messages. Use of queues optimize system operation by allowing parameters from multiple messages to be passed simultaneously to a database accessor 126. The queues 124 pass the parsed information to the database accessor 126 that will insert the data from the queues 124 into the relational database 128. Database accessor 126 is a generic interface with the middleware 120 which facilitates a connection with relational database 128. The database accessor 126 registers the extracted process parameter data into the appropriately defined and stored process parameter value limits previously established by the user within the relational database 128.

The relational database 128 contains the record structure, further identified below, and also the process parameter value limits for the process to be tracked and monitored. The relational database 128 accepts the inputs from the database accessor 126 and operationally functions as a repository of process parameter data. Each type of data is placed in a dedicated pre-defined table 129. Typically, data is inserted into multiple tables, specifically identified below, depending on which type of data has been inserted. Upon data registration, the relational database 128 initiates a trigger 132 which compares the just-inserted process parameter data 131 with the known process parameter value limits 133 already resident within the relational database 128. Within the relational database 128, the pre-programmed process parameter value limits are stored in a series of tables as described below. The trigger 132 compares the just-inserted process parameter data with the pre-programmed process parameter value limits stored in the relational database 128. Should the data not match the process parameter value limits, the trigger 132 interfaces with an alert system 130 for notification.

In an exemplary embodiment, the alert system 130 connects to the trigger 132 and is comprised of TCP client 134, TCP interface 136, TCP server 138, alert message 140, and an electronic mail application 142. TCP client 134 directly interfaces with trigger 132 and is the alert message communications mechanism. Once the trigger 132 detects an error, the TCP client packages the alert message for transport. TCP client 134 is connected via TCP interface 136 to TCP server 138. TCP interface 136 sends the alert message to TCP server 138. The TCP server 138 prepares the alert message 140 for transport to the designated recipient. Upon alert message completion, TCP server 138 passes the alert message to the electronic mail application 142 for distribution to the designated alert list recipients, using the alert mechanism specified in the alert list table.

By way of implementation of the exemplary embodiment, the process to be monitored may be broken down into specific process parameter value limits 133 and those process parameter value limits are stored in tables 129 in the relational database 128. The process parameter value limits may include: transactions, transaction types, routes through the network, auxiliary data unique to the process, messages, message types, systems, system types, alert types, alert lists and database accessor lists.

Exemplary transactions parameters, shown in Table 1, are pre-programmed into relational database 128. A transaction identifier (TID) is a unique number assigned to a specific transaction with each transaction receiving a TID. A transaction type identifier (TTID) is a number assigned to a particular type of transaction. For example, a sales order may be a type 1 and have the TTID field in the table filled in with that number, while a customer electronic mail message may have a TTID of 2. Exemplary types of transactions include: sales orders, customer electronic mail messages, order status queries, purchase order acceptance notifications, purchase order cancellation notifications, purchase order requests, return orders, etc., with a unique TTID number. The transaction table may also include a time stamp identifying the time of receipt of the message. The transactions table, illustrated as Table 1, may also include a global process identifier, (GPID). The GPID is the order number for a particular transaction and is therefore, unique to a transaction. The GPID allows retrieval of information and messages pertaining to the order corresponding to the GPID number. The GPID is a global identifier for a particular order and may be used to track the order throughout the process from beginning to end. Also found in the transactions table is an Alert List Identifier (ALID) which designates the recipients of any alert messages that may need to be sent. A specific list of stations or individual recipients may be given in each alert list. Furthermore, a network may have multiple database accessors operating in parallel to facilitate high traffic volume. Each database accessor may include a unique identifier, EID, for routing messages through the network.

TABLE 1

| FIELD | | | | |
|---|---|---|---|---|
| NAME | EXPLANATION | TYPE | DESCRIPTION | KEYS |
| TID | Transaction | Number | Unique number | Primary key |
| | Identifier | | assigned to a | |
| | | | specific | |
| | | | transaction | |
| TTID | Transaction Type | Number | Number assigned | Foreign key |
| | Identifier | | to a specific type | in transaction |
| | | | of transaction | types table |
| TIMESTAMP | Time of entry | Time | Time when | |
| | | | message crossed | |
| | | | electronic | |
| | | | threshold | |
| GPID | Global Process | Various | Unique identifier | |
| | Identifier | characters- | among multiple | |
| | | up to 100 | transactions | |
| ALID | Alert List | Number | Tells which Alert | Foreign key |
| | Identifier | | list to send an | in Alert List |
| | | | Alert message | table |
| EID | Database | Number | Tells which | Foreign key |
| | Accessor | | Database | in Database |
| | Identifier | | Accessor | Accessor |
| | | | inserted the data | table |

A transactions type table, illustrated in Table 2, contains a list of transaction types and numbers assigned to identify them. The transaction type table includes the TTID described above and also includes a description of the transaction in the description field of the table.

TABLE 2

| FIELD NAME | EXPLANATION | TYPE | DESCRIPTION | KEYS |
|---|---|---|---|---|
| TTID | Transaction Type | Number | Number assigned | Primary |
| | Identifier | | to a specific type | key |
| | | | of transaction | |
| DESCRIPTION | Described | Various | Perform operation | |
| | transaction | characters- | on data | |
| | | up to 100 | | |

A routes table, illustrated as Table 3, may include the following fields: TID as described above, Source System Identifier (SSID), Source System Reference (SSR), Destination System Identifier (DSID), and Destination System Reference (DSR). The SSID is the number assigned to the source system of the message. The SSR is the order identifier in the originating system and may be various characters, up to 100 characters. Source systems may include such systems as: data warehouse, merchant server, warehouse management, returns and restocking, and SAP. The DSID is the destination system identifier and is the number assigned to the order by the receiving or destination system. The DSR is the order number in the destination system and may be various characters, up to 100 characters.

TABLE 3

| FIELD | | | | |
|---|---|---|---|---|
| NAME | EXPLANATION | TYPE | DESCRIPTION | KEYS |
| TID | Transaction | Number | Unique number | Foreign key in |
| | Identifier | | assigned to a | Transactions |
| | | | specific | table |
| | | | transaction | |
| SSID | Source System | Number | Number assigned | Foreign key in |
| | Identifier | | to the source | Transactions |
| | | | system of the | table |
| | | | message | |
| SSR | Source System | Various | Order number in | |
| | Reference | characters-up | other system that | |
| | | to 100 | interface with | |
| | | | network | |
| DSID | Destination | Number | Number assigned | Foreign key in |
| | System Identifier | | to the destination | Systems table |
| | | | system of the | |
| | | | message | |
| DSR | Destination | Various | Order number in | |
| | System Reference | characters-up | other system that | |
| | | to 100 | interfaces with | |
| | | | network | |

The relational database may also include an auxiliary data table, an example of which is shown in Table 4. The fields in Table 4 include: TID, NAME, and VALUE. The TID is the same as described above. The name refers to the name of the item ordered; however, the name field could also be descriptive of the action the process should engage. The VALUE field is the product identifier and may consist or various characters with length not to exceed 255 characters.

TABLE 4

| FIELD | | | | |
|---|---|---|---|---|
| NAME | EXPLANATION | TYPE | DESCRIPTION | KEYS |
| TID | Transaction | Number | Unique number | Foreign key |
| | Identifier | | assigned to a | in |
| | | | specific | Transactions |
| | | | transaction | table |
| NAME | Name | Various | Name of item | |
| | | characters-up | ordered | |
| | | to 100 | | |
| VALUE | Value | Various | Product identifier | |
| | | characters-up | | |
| | | to 255 | | |

The business process to be tracked and monitored generates electronic messages as the process operates. These messages may be tracked and monitored through the use of the messages table, shown in Table 5. This table includes the following fields: TID, Message Type Identifier (MTID), and MESSAGE. The TID has been described previously. The MTID is a number assigned to a particular type of message. Message types may include the following: error, debug, success and informational. Messages may include such activities as an order submitted to the SAP, read data from queue, and informing user that a material number does not exist.

TABLE 5

| FIELD | | | | |
|---|---|---|---|---|
| NAME | EXPLANATION | TYPE | DESCRIPTION | KEYS |
| TID | Transaction | Number | Unique number | Foreign key |
| | Identifier | | assigned to a | in |
| | | | specific | Transactions |
| | | | transaction | table |
| MTID | Message Type | Number | Number assigned | Foreign key |
| | Identifier | | to a specific type | in Messages |
| | | | of message | Types table |
| MESSAGE | Message | Various | Describes action | |
| | | characters-up | | |
| | | to 100 | | |

The message types tables, an example of which is illustrated as Table 6, provides a list of the MTID numbers used along with a description of the alert message. The description of the message may be up to 255 characters in length. A message type table is shown as Table 6.

TABLE 6

| FIELD NAME | EXPLANATION | TYPE | DESCRIPTION | KEYS |
|---|---|---|---|---|
| MTID | Message Type | Number | Number assigned | Primary |
| | Identifier | | to a specific type | Key |
| | | | of message | |
| DESCRIPTION | Description | Various | Described | |
| | | characters-up | message | |
| | | to 255 | | |

A systems table, shown as Table 7, provides information on various systems that may interface to the network. The table may contain the following fields: System Identifier (SID), NAME, and System Type Identifier (STID). The SID is a unique number assigned to each system that interfaces with the network. The NAME field describes the system and may consist of various characters and be up to 255 characters long. The STID is a number designating the particular type of system, such as order or return. The STID consists of various characters and may be 100 characters long.

TABLE 7

| FIELD | | | | |
|---|---|---|---|---|
| NAME | EXPLANATION | TYPE | DESCRIPTION | KEYS |
| SID | System Identifier | Number | Unique number | Primary key |
| | | | assigned to a | |
| | | | system | |
| NAME | Name | Various | Described system | |
| | | characters-up | | |
| | | to 100 | | |
| STID | System Type | Number | Number assigned | Foreign key |
| | Identifier | | to a specific type | in System |
| | | | of system | Types table |

The systems type table, shown as Table 8, provides a list of each of the types of systems that interface with the network. Each system is assigned a number in the table. The TYPE field may provide a 100 character description of the system type. The VERSION field indicates the version and revision of the system and is similar to the familiar software revision numbers.

TABLE 8

| FIELD | | | | |
|---|---|---|---|---|
| NAME | EXPLANATION | TYPE | DESCRIPTION | KEYS |
| STID | System Type | Number | Number assigned | Primary |
| | Identifier | | to a specific type | key |
| | | | of system | |
| TYPE | Type | Various | Type of system | |
| | | characters- | | |
| | | up to 100 | | |
| VERSION | Version | Various | Version and | |
| | | characters | revision number | |
| | | up to 20 | of system | |

The exemplary embodiment of the present invention provides a means for alerting users to problems with the process being monitored and tracked, with such an alert being formulated and dispatched by an alert system 130. An alert types table, shown as Table 9, provides a listing of exemplary types of alerts. Alert type refers to the mechanism for delivering a message to a designated interested individual. This may be an electronic mail address to which a message is to be sent, a telephone number, or a fax machine number. The DESCRIPTION field provides a 100-character description of the alert mechanism.

TABLE 9

| FIELD NAME | EXPLANATION | TYPE | DESCRIPTION | KEYS |
|---|---|---|---|---|
| ATID | Alert Type | Number | Number assigned | Primary key |
| | Identifier | | to each type of | |
| | | | alert | |
| DESCRIPTION | Description | Various | Mechanism of | |
| | | characters-up | alert message | |
| | | to 100 | | |

Additional information used by the alert system may be found in an alert table, shown as Table 10. Fields included in the alert table are: Alert Identifier (AID) and Alert Type Identifier (ATID). ATID has been discussed above. The AID is a unique number assigned to each alert message.

TABLE 10

| FIELD | | | | |
|---|---|---|---|---|
| NAME | EXPLANATION | TYPE | DESCRIPTION | KEYS |
| AID | Alert Identifier | Number | Unique number | Primary key |
| | | | assigned to each | |
| | | | alert message | |
| ATID | Alert Type | Number | Number assigned | Foreign key |
| | Identifier | | to each type of | |
| | | | alert | |

The distribution of alerts is preferably handled through alert lists. An alert list is a listing of designated recipients of alert messages. Specific types of problems can be directed to specific individuals for resolution. An alert lists table is shown as Table 11 and may contain two fields: Alert List Identifier (ALID) and AID. AID has been discussed above. The ALID is a number that is related to a list of designated alert message recipients.

TABLE 11

| FIELD | | | | |
|---|---|---|---|---|
| NAME | EXPLANATION | TYPE | DESCRIPTION | KEYS |
| ALID | Alert List | Number | Number of | Primary key |
| | Identifier | | specific alert list | |
| | | | of alert message | |
| | | | recipients | |
| AID | Alert Identifier | Number | Unique number | Foreign key |
| | | | assigned to each | in Alerts |
| | | | alert message | table |

The exemplary embodiment of the present invention also provides message routing information. A database accessor table, shown as Table 12, tracks routing information and the database accessor table may contain two fields: Database Accessor Identifier abbreviated EID and DESCRIPTION. The EID is based on the route the message took through the network and reflects which database accessor inserted the data into the relational database. A unique number is used to identify each database accessor within the network. DESCRIPTION allows a 100-character name to be associated with each database accessor.

TABLE 12

| FIELD | EXPLANA- | | | |
|---|---|---|---|---|
| NAME | TION | TYPE | DESCRIPTION | KEYS |
| EID | Database | Number | Unique number | Primary |
| | Accessor | | assigned to each | key |
| | Identifier | | database | |
| | | | accessor | |
| DESCRIP- | Description | Various | Unique name | |
| TION | | characters - up | designating a | |
| | | to 100 | particular | |
| | | | database | |
| | | | accessor | |

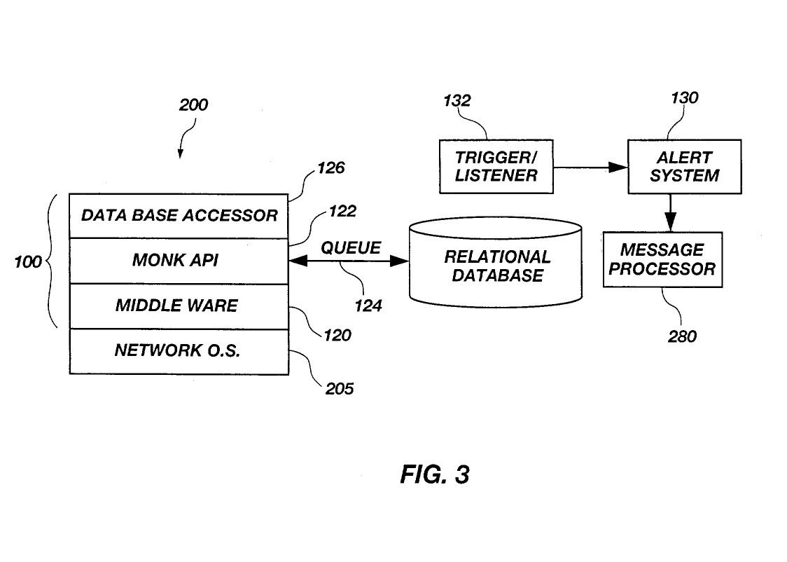

The present invention may operate in conjunction with a variety of software applications with these applications forming the backbone of the network and allowing the separate hardware items to be linked together. Software applications may reside on the network as shown in FIG. 3. A complete software suite 200 may reside on the network and may include the applications as shown in FIG. 3. The first level above the physical hardware level is the network operating system 205 which is responsible for the network and provides an interface between servers and the individual computers that comprise the network. Above the network operating system 205 is the middleware 120. An exemplary embodiment of the present invention uses middleware identified as “e*gate,” available from See Beyond Technology Corp., however, any standard middleware application package may be used. Middleware 120 provides a higher level of functionality which allows integration of software applications across the network. Middleware 120 processes and forwards the electronic messages that form the complete transaction with every message passing through the middleware 120.

The Monk API 122 resides above middleware 120, as shown in FIG. 3. While Monk is an exemplary programming language used by the exemplary embodiment of the present invention, any suitable programming language, including Java, may be used. The Monk API 122 listens to the messaging occurring in the middleware 120 and parses each message for the process parameter data for inserting in the tables 129 (FIG. 2) in the relational database 128. A database accessor 126 is a point of entry for data insertion into the relational database 128. Database accessor 126 extracts the parsed process parameter data from the queues 124 forwarded via the Monk API 122 to the tables 129 of the relational database 128 (all FIG. 2). An exemplary relational database 128 available from Oracle Corp. of Redwood Shores, California, however, a typical relational database may also be used. The database accessor 126 facilitates interconnection with the relational database 128 with a trigger or listener 132 reviewing the inserted process parameter data and verifying or comparing process parameter data 131 with the stored process parameter value limits 133 found in the tables 129 stored in the relational database 128. Should an entry in process parameter data be out of sequence, wrong or otherwise incorrect, the trigger 132 interfaces with the alert system 130 which sends an alert message to a specified list of responsible persons. The alert system 130 may use an electronic messaging processor or application 280 that is compatible with the middleware 120 and other software applications running on the network.

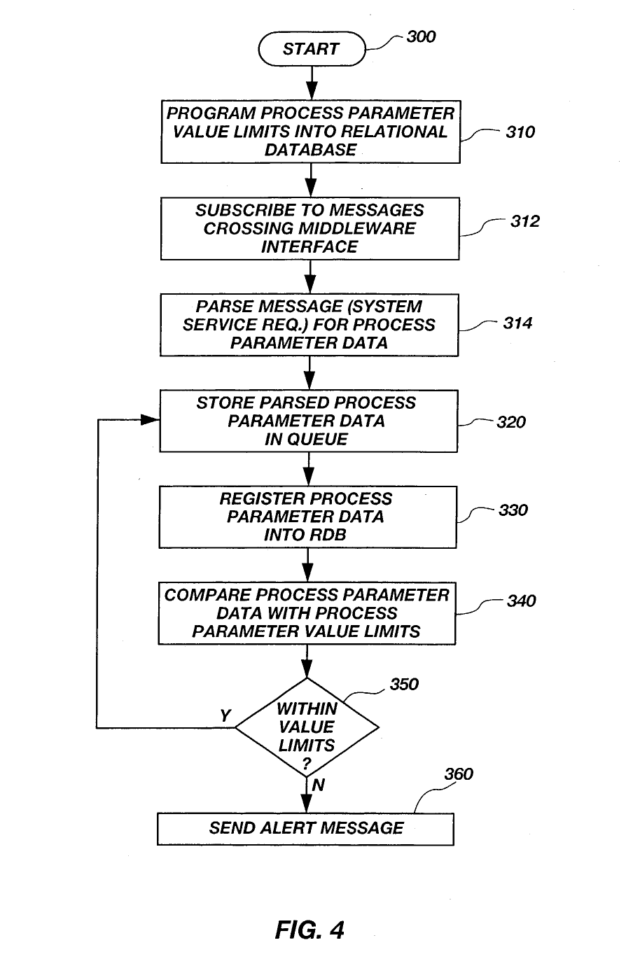

FIG. 4 is a flowchart of monitoring process 300, in accordance with an exemplary embodiment of the present invention. Process parameter value limits are programmed 310 into the tables 129 (FIG. 2) of the relational database 128 (FIG. 2). Tables 129 may be further generalized from the specific example described in the preceding tables, and may vary depending on the specific nature of the process to be monitored.

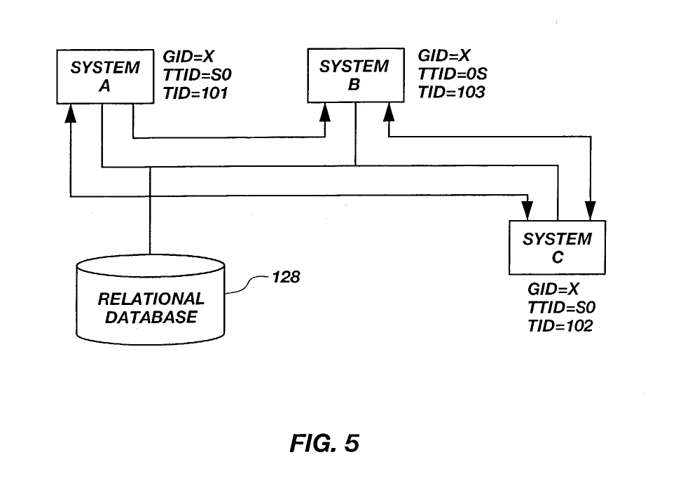

While the present process example is an electronic order fulfillment process, it is only exemplary of one type of process suitable for monitoring. The present invention is best understood by following a typical message through an exemplary monitoring process, in accordance with an embodiment of the invention. In the exemplary embodiment, middleware 120 subscribes 312 to all messages crossing the interface for facilitating access to the process parameter data for monitoring. The monitoring process 300 begins when a first system service request in the form of a message is sent across the multiple-application network. Middleware 120 (FIG. 2) begins processing the message. An example according to the process of FIG. 4 is illustrated in FIG. 5 and referencing alternates between the respective figures. The received system service request is assigned a GID. The Monk API 122 may parse the received system service request for time, source system, destination system, type of message, and other information as required by the tables 129 (FIG. 2) identified for the process. When information about the transaction needs to be tracked by database accessor 126 after picking up the message, the database accessor 126 first updates the transactions table, with the TTID. In the example transaction a sales order is type 1 while an order status is type 2. The database accessor also timestamps the time of logging the message into the relational database 128, shown in FIG. 2. A database accessor identifier, EID, is also entered into the transactions table. An ALID is also entered into the transactions table. This parsed process parameter data is put into a queue 124. The database accessor 126 reads the information from the queue 124 and the queue 124 inserts the data into the relational database 128. This step is shown as 330 in FIG. 4. This insertion into the transactions table returns a TID for the specific database accessor that performed the insertion. The TID is used to update the routes table which gives the source and destination identifiers for the particular database accessor in each system. In the example embodiment, this could be order number Y in system B and Z in system C shown as in FIG. 5. The TID is also used to update the messages table with the message and an associated MTID identifying the particular type of message. Data can also be entered into the auxiliary data table using the TID.

Once the process parameter data registered 330 into the relational database 128 a database trigger 132 is called which compares 340, 350 the process parameter data with the process parameter value limits already resident within the relational database 128. Within the relational database 128, the pre-programmed process parameter value limits are stored in a series of tables 129 (FIG. 2). If the message contains information that is not in accord with the process parameter value limits or is otherwise unacceptable, the trigger 132 sends 360 the message information to the alert system 130 (FIG. 2). The alert system 130 is a message system compatible with the utilized middleware. The alert message 140 may be sent using an electronic mail application 142, as shown in FIG. 2.

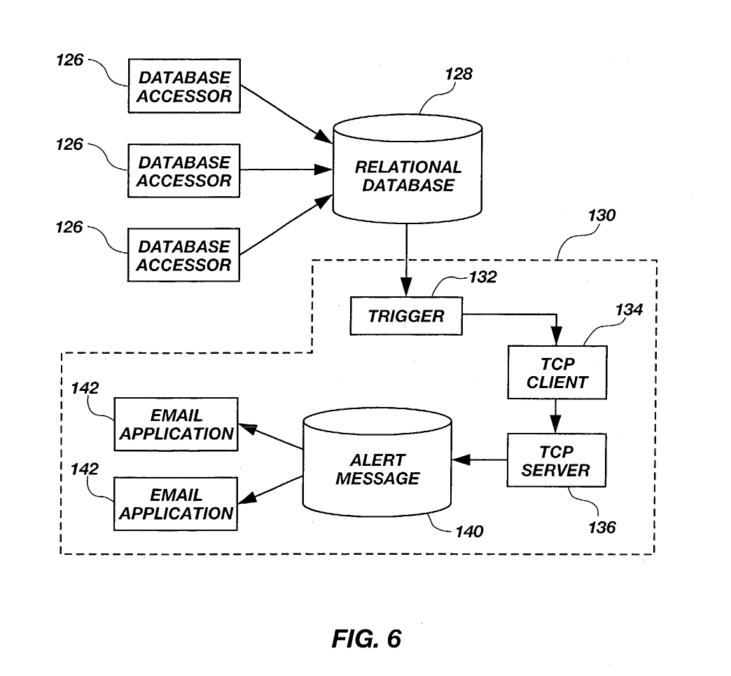

FIG. 6 is a block diagram of an alert system, in accordance with an embodiment of the present invention. The alert system 130 interfaces with the relational database 128 through the trigger 132. The database accessor 126 registers data into the relational database which triggers database trigger 132, which, in turn, calls the TCP client 134. The TCP client 134 collects the needed alert information and sends the alert information to the TCP server 136. The alert message 140 is then sent to an alert message queue (not shown) which are processed, in one embodiment, by electronic mail application 142, as needed, to accommodate the volume of the system. If not part of the middleware, the electronic mail application should be compatible with the selected middleware. The middleware made by See Beyond Technology Corp. is an example of a middleware that includes an electronic mail application.

The present invention solves the problems of identifying and locating problems within an electronic an integrated system. The need for tracking records across a network of linked applications is met by the present invention, which provides a method of monitoring end-to-end business processes across an integrated system.

Although the present invention has been described in considerable detail with reference to certain preferred versions thereof, other versions are possible. For example, the user may track and monitor other business process such as returns, equipment management, and any other process using electronic messages. Therefore, the spirit and scope of the appended claims should not be limited to the description of the preferred version contained herein.

What is claimed is:

1. A method for monitoring a process, comprising:
subscribing to at least one system service request designating said process;
parsing said at least one system service request for said process parameter data identifying at least one monitored process parameter;
inserting said parsed process parameter data into a queue;
registering said queue containing said process parameter data into a relational database;
comparing said process parameter data with stored process parameter value limits defining an acceptable range for said process parameter data in said relational database; and
when said process parameter data exceeds said stored process parameter value limits, generating an alert message identifying said stored parameter process data exceeding said stored process parameter value limits.

2. The method of claim 1, wherein said alert message includes identifying a source of said stored process parameter data exceeding said stored process parameter value limits.

3. The method of claim 1, further comprising routing said alert message to a designated recipient associated with said process parameter value limits.

4. The method of claim 3, wherein said alert message is an electronic notification for routing to said designated recipient.

5. The method of claim 1, wherein said alert message includes identifying said system service request containing process parameter data failing to match said stored process parameter value limits.

6. A system for monitoring a process spanning first and second applications, comprising:
a middleware application for overlaying said first and second applications, said middleware application configured for subscribing at least one process having process parameter data identifying at least one monitored process parameter;
a relational database configured for storing process parameter value limits defining an acceptable range for said process parameter data;
a trigger for comparing said process parameter value limits with process parameter data; and
an alert system configured to issue an alert message when said process parameter data exceeds said process parameter value limits.

7. The system of claim 6, further comprising:
an application program interface configured to parse said process parameter data from said at least one process;
a queue configured to receive said process parameter data identified by said application program interface; and
a database accessor coupled to said queue and configured to insert said process parameter data into said relational database.

8. The system of claim 6, wherein said alert system is further configured to route said alert message to a designated recipient associated with said process parameter value limits.

9. The system of claim 8, wherein said alert system is further configured to route said alert message to said designated recipient via one of email, facsimile and wireless means.

10. The system of claim 8, wherein said alert system further comprises an electronic mail application for routing said alert message to said designated recipient.

11. The system of claim 6, wherein said alert system is further configured to identify a source of said process parameter data exceeding said process parameter value limits.

12. The system of claim 6, wherein said alert system further comprises:
a TCP client application;
a TCP server connected to said TCP application by a TCP interface; and
wherein said alert message is sent by said TCP server.

13. In an Enterprise Application Integration system, a process monitoring system, comprising:
at least one process spanning first and second applications;
middleware application overlaying said first and second applications configured for subscribing and publishing inputs of said process;
an application program interface coupled with said middleware application, said application program interface configured to identify process parameter data from said at least one process;
a queue interfacing with said application program interface for receiving process parameter data from said application program interface when said application program interface identifies said process parameter data from said at least one process;
a database accessor operably coupled to said queue;
a relational database coupled to said database accessor, said relational database configured to receive said process parameter data and further configured to store process parameter value limits defining an acceptable range for said process parameter data in said relational database, said database accessor further configured for inserting said process parameter data into said relational database;
a trigger configured to compare said process parameter value limits with said process parameter data, said trigger means in communication with said relational database; and
an alert system configured to issue an alert message when said process parameter data exceeds said process parameter value limits.

14. The process monitoring system of claim 13, wherein said alert system is further configured to route said alert message to a designated recipient associated with said process parameter value limits.

15. The process monitoring system of claim 14, wherein said alert system is further configured to route said alert message to said designated recipient via one of email, facsimile and wireless means.

16. The process monitoring system of claim 13, wherein said alert system further comprises an electronic mail application for routing said alert message to said designated recipient.

17. The process monitoring system of claim 13, wherein said alert system is further configured to identify a source of said process parameter data exceeding said process parameter value limits.

18. A computer-readable medium having computer-executable instructions for monitoring a process, comprising:
subscribing to at least one system service request designating said process;
parsing said at least one system service request for said process parameter data identifying at least one monitored process parameter;
inserting said parsed process parameter data into a queue;
registering said queue containing said process parameter data into a relational database;
comparing said process parameter data with stored process parameter value limits defining an acceptable range for said process parameter data in said relational database; and
when said process parameter data exceeds said stored process parameter value limits, generating an alert message identifying said stored parameter process data exceeding said stored process parameter value limits.

19. The computer-readable medium of claim 18 having further computer-executable instructions for identifying a source of said stored process parameter data exceeding said stored process parameter value limits.

20. The computer-readable medium of claim 18 having further computer-executable instructions for routing said alert message to a designated recipient associated with said process parameter value limits.

21. The computer-readable medium of claim 20 having further computer-executable instructions for routing and electronic message to said designated recipient.

22. The computer-readable medium of claim 18 having further computer-executable instructions for identifying said system service request containing process parameter data failing to match said stored process parameter value limits.
